(19) United States
(12) Patent Application Publication
(10) Pub. No.: US 2026/0369472 A1
(43) Pub. Date: Nov. 19, 2026

(54) OUTLET TERMINAL ASSEMBLY FOR A DC LINK CAPACITOR WITH REDUCED EQUIVALENT SERIES INDUCTANCE

(71) Applicant: Rivian IP Holdings, LLC, Irvine, CA (US)

(72) Inventors: Seunghoon JEONG, La Mirada, CA (US); Juan LOPEZ, Wildomar, CA (US); Young DOO, La Palma, CA (US)

(21) Appl. No.: 19/275,908

(22) Filed: Jul. 21, 2025

Related U.S. Application Data
(60) Provisional application No. 63/805,876, filed on May 14, 2025.

(51) Int. Cl. H01G 2/04

(52) U.S. Cl. CPC H01G 2/04

(57) ABSTRACT

A DC link capacitor for a traction inverter system includes a plurality of capacitors, a plurality of first outlet flanges coupled to the plurality of capacitors, and a single second outlet flange coupled to the plurality of capacitors. The single second outlet flange extends over all of the plurality of first outlet flanges such that the single second outlet flange substantially entirely overlaps the plurality of first outlet flanges and such that a plurality of regions of the single second outlet flange are exposed adjacent the plurality of first outlet flanges. An insulator may be positioned between the plurality of first outlet flanges and the single second outlet flange. The insulator may include protrusions to facilitate alignment with respect to the first outlet flanges and the single second outlet flange.

### RELATED APPLICATION

This application claims the benefit of U.S. Provisional Application Ser. No. 63/805,876, filed May 14, 2025, and entitled OUTLET TERMINAL ASSEMBLY FOR A DC LINK CAPACITOR WITH REDUCED EQUIVALENT SERIES INDUCTANCE.

### INTRODUCTION

The present disclosure relates to outlet terminals of a DC link capacitor with reduced low equivalent series inductance (ESL).

### SUMMARY

The present disclosure describes an approach for implementing outlet terminals, such as for a DC link capacitor. For example, a vehicle component may include a plurality of capacitors and a plurality of first outlet flanges coupled to the plurality of capacitors. The vehicle component further includes a single second outlet flange coupled to the plurality of capacitors and extending over all of the plurality of first outlet flanges such that the single second outlet flange substantially entirely overlaps the plurality of first outlet flanges and such that a plurality of regions of the single second outlet flange are exposed adjacent the plurality of first outlet flanges.

In some embodiments, the plurality of first outlet flanges are distributed along a first direction and define cutouts therebetween that extend inwardly from distal edges of the plurality of first outlet flanges along a second direction perpendicular to the second direction by an extent. The single second outlet flange may extend completely across the plurality of first outlet flanges in the first direction and extend across the plurality of first outlet flanges along the second direction by at least the extent, a distal edge of the single second outlet flange being substantially aligned and coincident with the distal edges of the plurality of first flanges along the first direction.

The vehicle component may further include a first mounting flange secured to the plurality of first outlet flanges and coupled to the plurality of capacitors and a second mounting flange secured to the single second outlet flange and coupled to the plurality of capacitors.

The vehicle component may further include a first contact plate and a second contact plate, the plurality of capacitors being positioned between the first contact plate and the second contact plate, the first mounting flange being fastened to the first contact plate and the second mounting flange being fastened to the second contact plate.

In some embodiments, the first mounting flange is substantially parallel to the plurality of first outlet flanges and the second mounting flange is substantially perpendicular to the single second outlet flange.

The vehicle component may further include an insulator positioned between the plurality of first outlet flanges and the single second outlet flange.

In some embodiments, the insulator includes cutouts such that the plurality of regions of the single second outlet flange are exposed through the cutouts.

In some embodiments, the insulator includes a plurality of first protrusions extending from a first side of the insulator and a plurality of second protrusions extending from a second side of the insulator opposite the first side, the plurality of first protrusions facilitating alignment of the plurality of first outlet flanges with respect to the insulator and the plurality of second protrusions facilitating alignment of the single second outlet flange with respect to the insulator.

In some embodiments, the plurality of first protrusions include ridges extending around the cutouts and facilitating alignment of the plurality of first outlet flanges with respect to the insulator.

In some embodiments, the plurality of second protrusions engage one or more edges of the single second outlet flange.

In some embodiments, the insulator includes one or more first protrusions and one or more second protrusions; the plurality of first outlet flanges defines one or more first openings, the one or more first protrusions being inserted in the one or more first openings; and the single second outlet flange defines one or more second openings, the one or more second protrusions being inserted within the one or more second openings.

The vehicle component may further include a first mounting flange secured to the plurality of first outlet flanges and a second mounting flange secured to the single second outlet flange, the insulator including an insulator flange extending along the second mounting flange.

In some embodiments, the first mounting flange is substantially parallel to the plurality of first outlet flanges and the second mounting flange is substantially perpendicular to the single second outlet flange; and the first mounting flange is connected to the plurality of first outlet flanges with an offset, the insulator flange extending between the offset and the second mounting flange.

The vehicle component may further include inverter switches including a plurality of first inlet terminals connected to the plurality of first outlet flanges and a plurality of second inlet terminals connected to the plurality of regions.

The vehicle component may further include a control module configured to actuate the inverter switches to generate three-phase

the plurality of first outlet flanges being three first outlet terminals, the plurality of regions being three regions, the plurality of first inlet terminals being three first inlet terminals, and the plurality of second inlet terminals being three second inlet terminals.

In another aspect, a terminal assembly includes a plurality of first outlet flanges and a single second outlet flange offset from the plurality of first outlet flanges by less than two millimeters and extending over all of the plurality of first outlet flanges, wherein the single second outlet flange substantially entirely overlaps the plurality of first outlet flanges, and a plurality of regions of the single second outlet flange are exposed adjacent the plurality of first outlet flanges. The terminal assembly further includes an insulator positioned between the plurality of first outlet flanges and the single second outlet flange. The insulator defines cutouts such that the plurality of regions of the single second outlet flange are exposed through the cutouts. The insulator includes a plurality of first protrusions extending from a first side of the insulator and a plurality of second protrusions extending from a second side of the insulator opposite the first side, the plurality of first protrusions facilitating alignment of the plurality of first outlet flanges with respect to the insulator and the plurality of second protrusions facilitating alignment of the single second outlet flange with respect to the insulator.

The terminal assembly may further include a first mounting flange secured to the plurality of first outlet flanges and a second mounting flange secured to the single second outlet flange, the insulator including an insulator flange extending along the second mounting flange.

In some embodiments, the first mounting flange is substantially parallel to the plurality of first outlet flanges and the second mounting flange is substantially perpendicular to the single second outlet flange; and the first mounting flange is connected to the plurality of first outlet flanges by an offset, the insulator flange extending between the offset and the second mounting flange.

In some embodiments, the plurality of first protrusions include ridges extending around the cutouts and facilitating alignment of the plurality of first outlet flanges with respect to the insulator.

In some embodiments, the plurality of second protrusions engage one or more edges of the single second outlet flange.

In some embodiments, the plurality of first outlet flanges defines one or more first openings, one or more protrusions of the plurality of first protrusions being inserted in the one or more first openings; and the single second outlet flange defines one or more second openings, the one or more protrusions of the plurality of second protrusions being inserted within the one or more second openings.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic block diagram illustrating power electronics of a vehicle in accordance with certain embodiments.

FIG. 4 is an isometric view of a DC link capacitor with low equivalent series inductance (ESL) output terminals in accordance with certain embodiments.

FIG. 5 is an isometric view of low ESL output terminals in accordance with certain embodiments.

FIGS. 6A and 6B are isometric views of an insulator for positioning between the low ESL output terminals in accordance with certain embodiments.

FIG. 7A is a front view of the low ESL output terminals with the insulator in accordance with certain embodiments.

FIG. 7B is a top view of the low ESL output terminals with the insulator in accordance with certain embodiments.

FIG. 7C is a bottom view of the low ESL output terminals with the insulator in accordance with certain embodiments.

FIG. 7D is a side view of the low ESL output terminals with the insulator in accordance with certain embodiments.

FIG. 8 is a top view of a traction inverter system including the low ESL output terminals and the insulator in accordance with certain embodiments.

### DETAILED DESCRIPTION

The DC link capacitor of a traction inverter system connects inverter switches to a battery. Since large oscillating currents flow through the DC link capacitor, any inductance of components will cause parasitic impedance. Inlet terminals for a DC link capacitor are described herein that have reduced inductance and therefore reduce the overall impedance of the DC link capacitor.

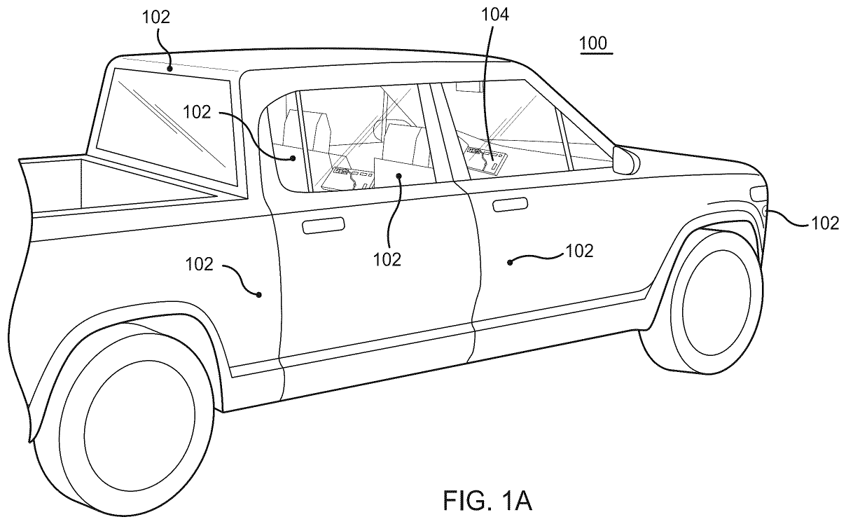

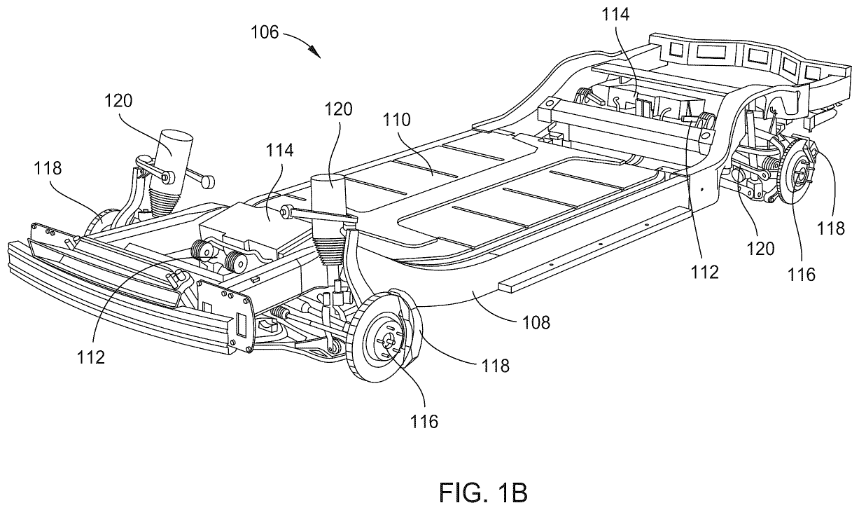

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more traction inverter systems 114, such as a traction inverter system 114 for each drive unit 112 or pair of drive units 112. The traction inverter systems 114 may include inverters configured to convert direct current (DC) from the battery 110 into alternating current (AC) supplied to the motors of the drive units 112. The traction inverter systems 114 further facilitate operation of the motors of the drive units as generators to provide regenerative braking. The traction inverter systems 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, a hybrid-electric vehicle may also benefit from the approach described herein. Likewise, non-vehicular applications that use an inverter or other relevant power component may also benefit from the approach described herein.

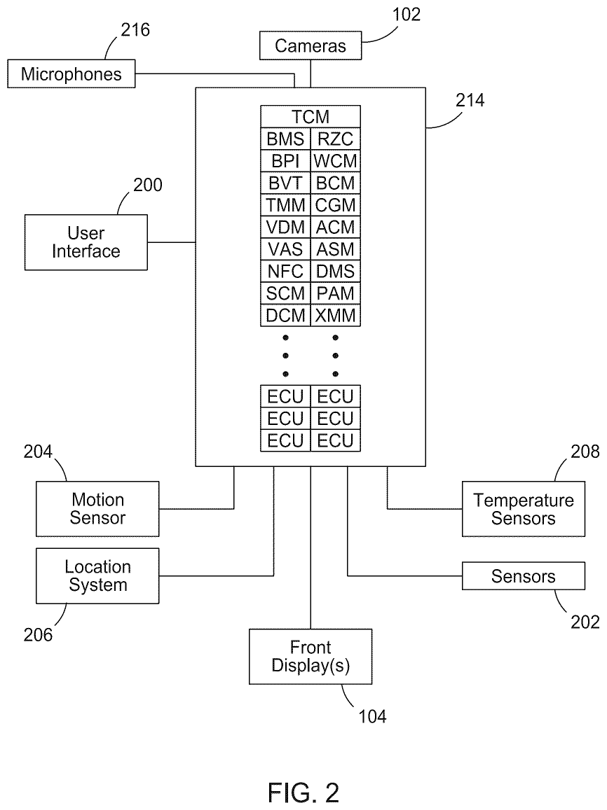

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of traction inverter systems 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor directly mounted to a microprocessor of the traction inverter systems 114.

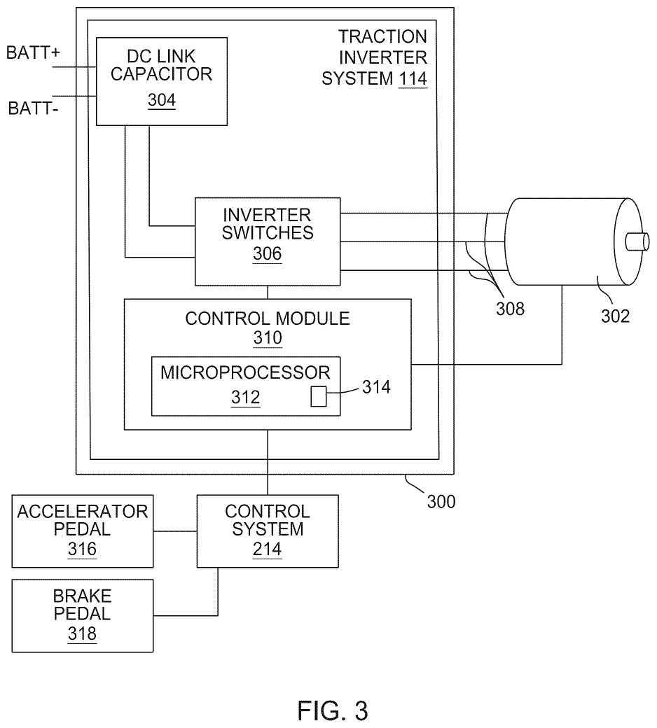

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

Referring to FIG. 3, the traction inverter system 114 may be contained within a housing 300, such as a housing made of aluminum or steel. The traction inverter system 114 may include a plurality of components configured to convert direct current (DC) from the battery 110 into alternating current (AC), such as three-phase AC, supplied to one or more motors 302 of the drive unit 112 including the traction inverter system 114.

The traction inverter system 114 may include a DC link capacitor 304 that receives power from the battery 110 and is coupled to the positive and negative terminals (Batt+, Batt−) of the battery 110. The DC link capacitor 304 functions to smooth current received from the battery 110 as part of the process by which the direct current from the battery 110 is converted to an approximately sinusoidal alternating current. The DC link capacitor 304 may further function to dampen any voltage spikes. The DC link capacitor 304 may be within the housing 300 or external to the housing 300.

The traction inverter system 114 may include inverter switches 306 coupled to the outputs of the DC link capacitor 304. The inverter switches 306 may include a plurality of switches that are selectively opened and closed to cause transmission of current to the outputs of the traction inverter system 114 at an appropriate frequency for driving the one or more motors 302. For example, the inverter switches 306 may output three-phase current over lines 308 connecting the inverter switches 306 to the motor 302. The opening and closing of the inverter switches 306 may be controlled by a control module 310. The control module 310 may include a printed circuit board with various electronic components configured to generate the control signals for the inverter switches 306. In some embodiments, the traction inverter system 114 drives two drive units 112 and includes separate printed circuit boards for supplying current to the motors 302 of the separate drive units.

The control module 310 may further include a microprocessor 312 programmed to control operation of the control module 310 and therefore the inverter 306. The microprocessor 312 may be embodied as a silicon chip mounted to the printed circuit board of the control module 310. The microprocessor 312 may include a temperature sensor 314 mounted directly thereto.

The control module 310 may be coupled to the control system 214 and implement instructions from the control system 214 to control current supplied to the motor 302 and to cause the motor 302 to produce regenerative current. The control system 214 may generate such instructions as part of an automated driving algorithm (e.g., automatic cruise control), safety algorithm (e.g., traction control, stability control, automated emergency braking), or in response to inputs from a driver by way of an accelerator pedal 316 and/or brake pedal 318.

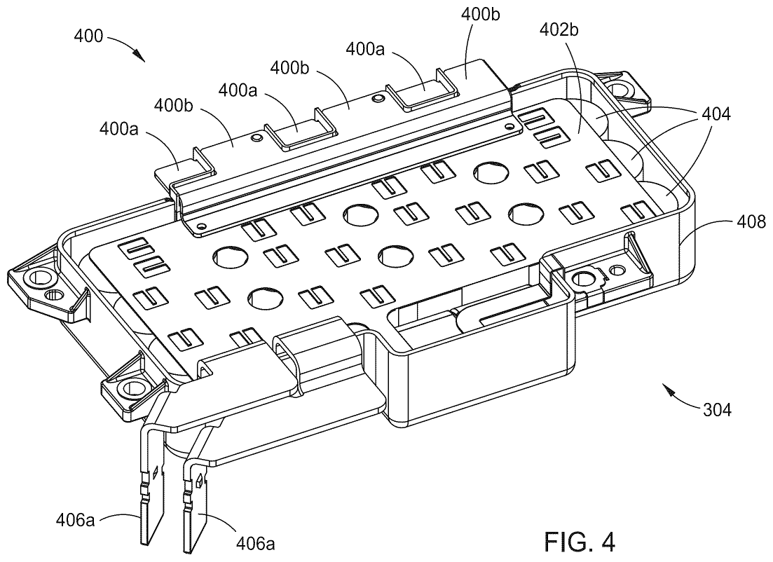

Referring to FIG. 4, the DC link capacitor 304 may include an outlet terminal assembly 400 for connecting to the inverter switches 306. As described in greater detail below, the outlet terminal assembly 400 may be configured to reduce equivalent series inductance (L) (ESL) thereof. Due to the high amount of oscillating current passing through the outlet terminal assembly 400, time-varying magnetic fields and corresponding impedance is created. Using the outlet terminal assembly 400 as described herein, the ESL of the outlet terminal assembly 400 is reduced. The outlet terminal assembly 400 further provides efficient space utilization.

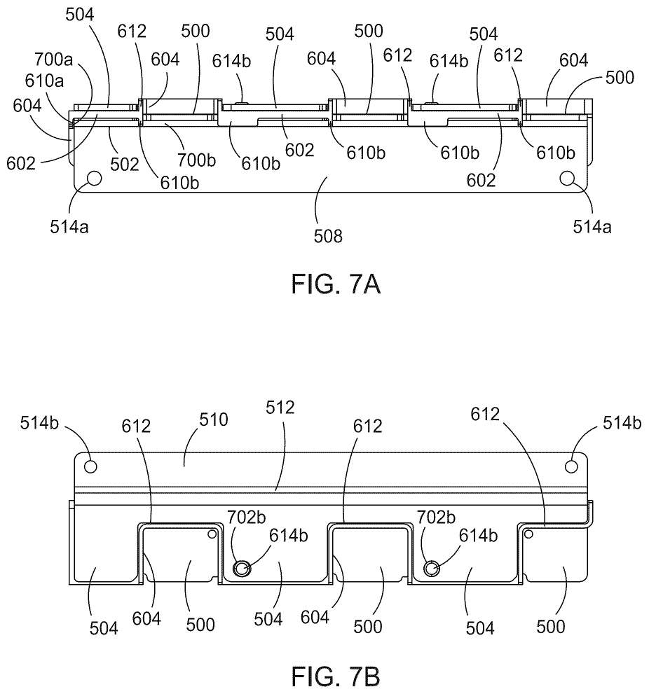

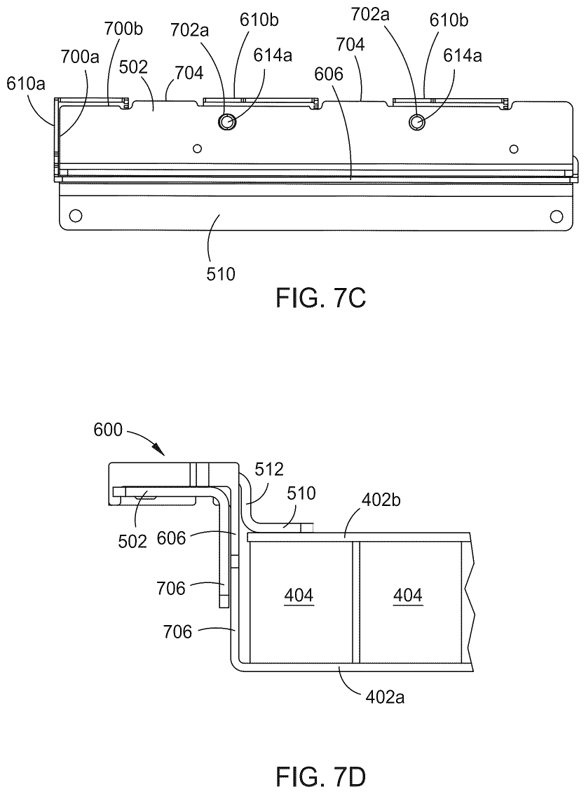

The outlet terminal assembly 400 may include positive outlet terminals 400a and negative outlet terminals 400b connected to a positive contact plate (see 402a in FIG. 7D) and a negative contact plate 402b, respectively, having a plurality of capacitors 404 positioned between, and in electrical contact with, the positive contact plate 402a and negative contact plate 402b. A positive inlet terminal 406a is connected to the positive contact plate and a negative inlet terminal 406b is connected to the negative contact plate. The positive and negative inlet terminals 406a, 406b receive direct current from the battery 110 that is to be converted to three-phase current by the traction inverter system 114.

The positive contact plate 402a, negative contact plate 402b, and capacitors 404 may be mounted within a housing 408 that is mounted within the housing 300 of the traction inverter system 114. The outlet terminal assembly 400 and the positive and negative inlet terminals 406a, 406b protrude outwardly from the housing 408.

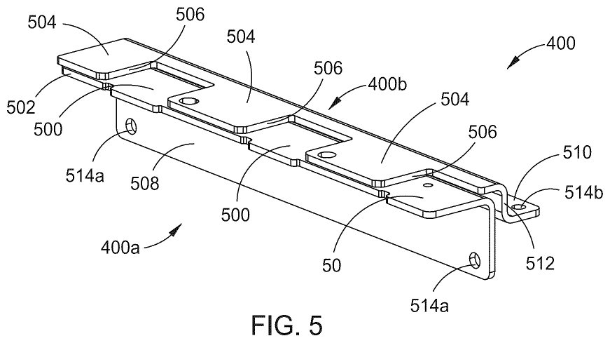

Referring to FIG. 5, the positive outlet terminals 400a may be embodied as regions 500 of a single flange 502 extending under flanges 504 forming the negative outlet terminals 400b. Stated differently, one of the positive outlet terminals 400a and the negative outlet terminals 400b may be formed by a plurality of first outlet flanges (e.g., the flanges 504) and the other of the negative outlet terminals 400b and the positive outlet terminals 400a may be formed by a single second outlet flange (e.g., the flange 502). The regions 500 may be exposed by cutouts 506 defined between the flanges 504. As is apparent in FIG. 5, the flange 502 is substantially (e.g., within 1 degree of) parallel to the flanges 504 and substantially (e.g., at least 99%) overlaps the flanges 504 in a plane parallel to the surface of the flange 502 interfacing with the flanges 504 (hereinafter “the parallel plane”). In some embodiments, the flanges 504 are distributed along a first direction in the parallel plane and the flange 502 may completely across the flanges 504 in the first direction. In some embodiments distal edges of the flanges 504 may be substantially aligned and coincident with the distal edge of the single flange 502 in the parallel plane along a second direction perpendicular to the first direction in the parallel plane, e.g., within 1 mm or 0.1 mm of aligned and coincident. The cutouts 506 may extend inwardly from distal edges of the flanges 504 in the second direction by an extent and the flange 502 may overlap the plurality of flanges 504 in the second direction by at least the extent.

The overlap between the flange 502 and the flanges 504 causes magnetic fields generated by the current through the flanges 502, 504 to counteract one another, since the current flowing through the flanges 500 and flanges 504 flows in opposite directions and corresponding magnetic fields are likewise opposite one another. Increasing the overlapping area of the flanges 504 (e.g., a plurality of first outlet flanges) and the flange 502 (e.g., a single second outlet flange) forming the positive outlet terminal helps to reduce the ESL of the DC link capacitor 304 and its interface with the inverter switches 306.

The flange 502 may be connected to a mounting flange 508 that is connected to the positive contact plate of the DC link capacitor 304. The mounting flange 508 may be substantially (e.g., within 2 degrees of) perpendicular to the flange 502 (e.g., to the parallel plane). The mounting flange 508 and flange 502 may be formed of a single piece of metal, e.g., steel, bent to form substantially perpendicular flanges 502, 508. Where the flange 502 is regarded as the second outlet flange, the mounting flange 508 may be considered to be a second mounting flange.

The flanges 504 may be connected to a mounting flange 510 that is substantially (e.g., within 2 degrees of parallel) to the flanges 504 (e.g., to the parallel plane). The mounting flange 510 may connect to the negative contact plate 402b. The mounting flange 510 may have at a different height than the flanges (e.g., measured perpendicular to the parallel plane) and therefore may connect to the flanges 504 by an offset 512. The flanges 504, mounting flange 510, and offset 512 may be formed of a single piece of metal, e.g., steel, bent to form the flanges 504, 510 and offset 512. Where the flanges 504 are regarded as the plurality of first outlet flanges, the mounting flange 510 may be considered to be a first mounting flange.

In some embodiments, the flange 502 and flanges 504 define openings 514a, 514b, respectively. The openings 514a, 514b may be used to position the positive outlet terminals 400a and negative outlet terminals 400b during assembly. The openings 514a, 514b may additionally or alternatively receive fasteners.

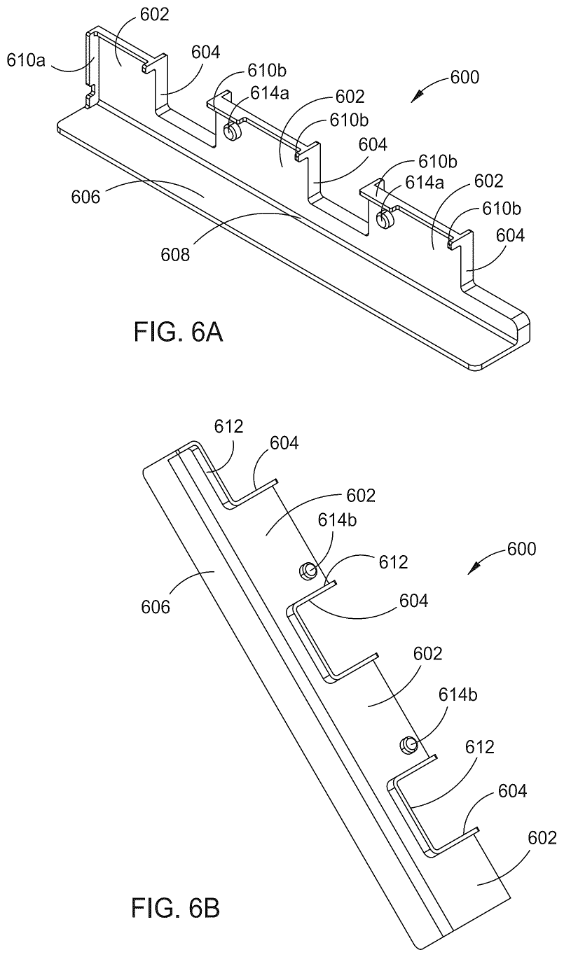

Referring to FIGS. 6A and 6B while still referring to FIG. 5, the flange 502 and flanges 504 may be maintained very close in order to reduce ESL, such as less than 1, 0.5, or 0.1 millimeter. In some embodiments, an insulator 600 may be interposed between the flange 502 and flanges 504 in order to enable a small gap therebetween while still preventing electric contact. The insulator 600 may be formed of plastic or other dielectric material. The insulator 600 may extend between the flange 502 and flanges 504 and may also extend between the offset 512 and the mounting flange 508 and any curved transition between the flange 502 and the mounting flange 508 and between the flanges 504 and the offset 512.

For example, the insulator 600 may include flanges 602 that extend between the flange 502 and the flanges 504 and may be oriented substantially (e.g., within 1 degree of) parallel to the parallel plane. The insulator 600 may include cutouts 604 between and to the side of the flanges 602 in order to leave the regions 500 exposed when the insulator 600 is assembled with the positive and negative outlet terminals 400a, 400b.

The insulator 600 may include a flange 606 (e.g., an insulator flange) that is substantially (e.g., within 2 degrees of) perpendicular to the flanges 602 and the parallel plane. The flange 606 may extend between the mounting flange 508 and the offset 512 (see FIG. 7D). A junction 608 between the flange 606 and the flanges 602 may conform to curved transitions between the flange 502 and the mounting flange 508 and/or the flanges 504 and the offset 512. Alternatively, the junction 608 may be sized to fit within a gap between the positive and negative outlet terminals 400a, 400b though not necessarily conforming to either.

Referring to FIGS. 7A to 7D while still referring to FIGS. 6A and 6B, the insulator 600 may include various features to facilitate alignment with respect to the positive and negative outlet terminals 400a, 400b. For example, as best seen in FIG. 6A, a protrusion, e.g., a lip 610a, may extend downwardly from an outermost flange 602, e.g., extend from the flange 602 in the same direction as the flange 606 and engage an edge of the positive terminal 400a, e.g., a first edge 700a of the flange 502. Protrusions 610b may be formed on some or all of the flanges 602 and extend downwardly therefrom. The protrusions 610b may engage a second edge 700b of the flange 502 perpendicular to the first edge 700a. Some flanges 602 may include two or more protrusions 610b. Where the flange 502 is regarded as a second outlet flange, the protrusions 610a, 610b may be regarded as plurality of second protrusions.

As best seen in FIG. 6B, ridges 612 may extend upwardly from the flanges 602, e.g., opposite the direction in which the flange 606 extends from the flanges 602. The ridges 612 may extend around the perimeters of the cutouts 604. Accordingly, when assembled with the positive and negative input terminals 400a, 400b, the flanges 504 of the negative terminal may seat adjacent and between the ridges 612 as best seen in FIGS. 7A and 7B. Where the flanges 504 are regarded as a plurality of first outlet flanges, the ridges 612a may be regarded as a plurality of first protrusions.

One or more of the flanges 602 may define one or more protrusions 614a extending downwardly from the flanges 602 and one or more protrusions 614b extending upwardly from the flanges 602. The positive outlet terminal 400a may define one or more openings 702a sized and positioned to receive the one or more protrusions 614a, as best seen in FIG. 7C. The negative outlet terminal 400b may define one or more openings 702b that are sized and positioned to receive the protrusions 614b, as best seen in FIGS. 7A and 7B. The engagement of the protrusions 614a, 614b with the openings 702a, 702b may facilitate alignment of the insulator 600 with respect to the positive and negative outlet terminals 400a, 400b. Where the flange 502 is regarded as the second outlet flange and the flanges 504 are regarded as the plurality of first outlet flanges, the one or more openings 702b may be regarded as one or more first openings, the one or more protrusions 614b may be regarded as one or more first protrusions, the one or more openings 702a may be regarded as one or more second openings, and the one or more protrusions 614a may be regarded as one or more second protrusions.

In some embodiments, although the flange 502 is a single flange, protrusions 704 from the second edge 700b of the flange 502 may extend at least partially across (e.g., over at least 75 percent of) the cutouts 506 defined by the flanges 504 and the cutouts 604 defined by the flanges 602.

Referring to FIG. 7D, the contact plates 402a, 402b (e.g., a first contact plate and a second contact plate, respectively) may be mounted to the mounting flanges 508, 510, respectively. The contact plates 402a, 402b may be fastened to the flanges 508, 510 using welding (e.g., laser welding or spot welding), fasteners (e.g., passing through openings 514a, 514b), or other type of fastener. The capacitors (e.g., the plurality of capacitors) may be positioned between the contact plates 402a, 402b and fastened thereto, such as using laser welding, soldering, or other fastening approach.

The contact plate 402a may have a flange 706 mounted thereto and extending between the contact plate 402a and the mounting flange 508. The contact plate 402a and flange 706 may be formed by bending a single piece of metal. The mounting of the contact plates 402a, 402b to the mounting flanges 508, 510 may be performed before or after assembly of the positive and negative outlet terminals 400a, 400b with the insulator 600.

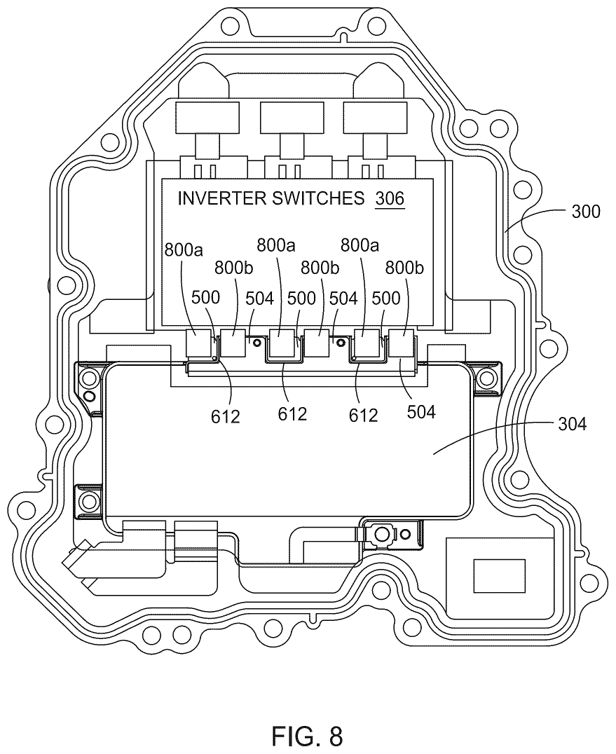

FIG. 8 illustrates the DC link capacitor 304 mounted within the housing 300 adjacent the inverter switches 306. The inverter switches 306 may include positive inlet terminals 800a and negative inlet terminals 800b. Since the inverter switches 306 output three-phase current, there may be three positive inlet terminals 800a and three negative inlet terminals 800b. The positive outlet terminal 400a may likewise include three regions 500 engaging with the three positive inlet terminals and the negative outlet terminal 400b may include three flanges 504. Where the flanges 504 are regarded as a plurality of first flanges and the flange 502 is regarded as a second flange, the negative inlet terminals 800b may be regarded as a plurality of first inlet terminals and the positive inlet terminals 800a may be regarded as a plurality of second inlet terminals.

When assembled, the three positive inlet terminals 800a may rest on the three regions 500 and may be fastened thereto by welding (e.g., laser welding), screws, or other fastener. The three negative inlet terminals 800b may rest on the three flanges 504 and be fastened thereto by welding, screws, or other fastener.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A vehicle component comprising:
a plurality of capacitors;
a plurality of first outlet flanges coupled to the plurality of capacitors; and
a single second outlet flange coupled to the plurality of capacitors and extending over all of the plurality of first outlet flanges, wherein the single second outlet flange substantially entirely overlaps the plurality of first outlet flanges, and a plurality of regions of the single second outlet flange are exposed adjacent the plurality of first outlet flanges.

2. The vehicle component of claim 1, wherein:
the plurality of first outlet flanges are distributed along a first direction and define cutouts therebetween that extend inwardly from distal edges of the plurality of first outlet flanges along a second direction perpendicular to the second direction by an extent; and
the single second outlet flange extends completely across the plurality of first outlet flanges in the first direction and extends across the plurality of first outlet flanges along the second direction by at least the extent, a distal edge of the single second outlet flange being substantially aligned and coincident with the distal edges of the plurality of first outlet flanges along the first direction.

3. The vehicle component of claim 1, further comprising:
a first mounting flange secured to the plurality of first outlet flanges and coupled to the plurality of capacitors; and
a second mounting flange secured to the single second outlet flange and coupled to the plurality of capacitors.

4. The vehicle component of claim 3, further comprising a first contact plate and a second contact plate, the plurality of capacitors being positioned between the first contact plate and the second contact plate, the first mounting flange being fastened to the first contact plate and the second mounting flange being fastened to the second contact plate;
wherein the first mounting flange is substantially parallel to the plurality of first outlet flanges and the second mounting flange is substantially perpendicular to the single second outlet flange.

5. The vehicle component of claim 1, further comprising an insulator positioned between the plurality of first outlet flanges and the single second outlet flange.

6. The vehicle component of claim 5, wherein the insulator includes cutouts such that the plurality of regions of the single second outlet flange are exposed through the cutouts.

7. The vehicle component of claim 6, wherein the insulator includes a plurality of first protrusions extending from a first side of the insulator and a plurality of second protrusions extending from a second side of the insulator opposite the first side, the plurality of first protrusions facilitating alignment of the plurality of first outlet flanges with respect to the insulator and the plurality of second protrusions facilitating alignment of the single second outlet flange with respect to the insulator.

8. The vehicle component of claim 7, wherein the plurality of first protrusions include ridges extending around the cutouts and facilitating alignment of the plurality of first outlet flanges with respect to the insulator.

9. The vehicle component of claim 7, wherein the plurality of second protrusions engage one or more edges of the single second outlet flange.

10. The vehicle component of claim 6, wherein:
the insulator includes one or more first protrusions and one or more second protrusions;
the plurality of first outlet flanges defines one or more first openings, the one or more first protrusions being inserted in the one or more first openings; and
the single second outlet flange defines one or more second openings, the one or more second protrusions being inserted within the one or more second openings.

11. The vehicle component of claim 6, further comprising:
a first mounting flange secured to the plurality of first outlet flanges and a second mounting flange secured to the single second outlet flange, the insulator including an insulator flange extending along the second mounting flange.

12. The vehicle component of claim 11, wherein:
the first mounting flange is substantially parallel to the plurality of first outlet flanges and the second mounting flange is substantially perpendicular to the single second outlet flange; and
the first mounting flange is connected to the plurality of first outlet flanges with an offset, the insulator flange extending between the offset and the second mounting flange.

13. The vehicle component of claim 1, further comprising inverter switches including a plurality of first inlet terminals connected to the plurality of first outlet flanges and a plurality of second inlet terminals connected to the plurality of regions.

14. The vehicle component of claim 13, further comprising a control module configured to actuate the inverter switches to generate three-phase current, the plurality of first outlet flanges being three first outlet terminals, the plurality of regions being three regions, the plurality of first inlet terminals being three first inlet terminals, and the plurality of second inlet terminals being three second inlet terminals.

15. A terminal assembly comprising:
a plurality of first outlet flanges;
a single second outlet flange offset from the plurality of first outlet flanges by less than two millimeters and extending over all of the plurality of first outlet flanges, wherein the single second outlet flange substantially entirely overlaps the plurality of first outlet flanges, and a plurality of regions of the single second outlet flange are exposed adjacent the plurality of first outlet flanges; and
an insulator positioned between the plurality of first outlet flanges and the single second outlet flange;
wherein the insulator defines cutouts such that the plurality of regions of the single second outlet flange are exposed through the cutouts; and
wherein the insulator includes a plurality of first protrusions extending from a first side of the insulator and a plurality of second protrusions extending from a second side of the insulator opposite the first side, the plurality of first protrusions facilitating alignment of the plurality of first outlet flanges with respect to the insulator and the plurality of second protrusions facilitating alignment of the single second outlet flange with respect to the insulator.

16. The terminal assembly of claim 15, further comprising:
a first mounting flange secured to the plurality of first outlet flanges and a second mounting flange secured to the single second outlet flange, the insulator including an insulator flange extending along the second mounting flange.

17. The terminal assembly of claim 16, wherein:
the first mounting flange is substantially parallel to the plurality of first outlet flanges and the second mounting flange is substantially perpendicular to the single second outlet flange; and
the first mounting flange is connected to the plurality of first outlet flanges by an offset, the insulator flange extending between the offset and the second mounting flange.

18. The terminal assembly of claim 15, wherein the plurality of first protrusions include ridges extending around the cutouts and facilitating alignment of the plurality of first outlet flanges with respect to the insulator.

19. The terminal assembly of claim 15, wherein the plurality of second protrusions engage one or more edges of the single second outlet flange.

20. The terminal assembly of claim 15, wherein:
the plurality of first outlet flanges defines one or more first openings, one or more protrusions of the plurality of first protrusions being inserted in the one or more first openings; and
the single second outlet flange defines one or more second openings, the one or more protrusions of the plurality of second protrusions being inserted within the one or more second openings.
